(19) United States
(12) Patent Application Publication
(10) Pub. No.: US 2011/0102767 A1
(43) Pub. Date: May 5, 2011

(54) LIGHTNING DETECTION

(76) Inventors: Mark Volanthen, Hampshire (GB); Mark Osborne, Hampshire (GB); Glynn David Lloyd, Birmngham (GB)

(21) Appl. No.: 12/933,488

(22) PCT Filed: Mar. 4, 2009
(86) PCT No.: PCT/GB2009/000608

§ 371 Date: Jan. 19, 2011

(30) Foreign Application Priority Data
Mar. 7, 2008 (GB) 0804215.2

(51) Int. Cl. G01B 11/16

(52) U.S. Cl. 356/32

(57) ABSTRACT

A device for detecting lightning currents in a wind turbine comprises an inductive loop (1) for carrying a current representative of a lightning current and a sensitive element, such as a resistance or a piezoelectric element electrically connected to the inductive loop (1). The apparatus further comprises an optical fibre strain sensor mechanically connected to the sensitive element, such that, in use, a lightning current results in expansion of the sensitive element and the optical fibre strain sensor produces an optical signal indicative of the strain on the sensitive element due to the expansion. The device has the advantage that the optical signal from the optical fibre strain sensor can be processed by the same signal processing equipment that processes signals from other strain sensors provided on the wind turbine.

### FIELD OF THE INVENTION

This invention relates to the detection of lightning strikes, in particular for identifying, and preferably quantifying, lightning strikes on wind turbines.

### BACKGROUND TO THE INVENTION

US 2008/17788 discloses a system for lightning detection. The system includes a conductor configured to receive a lightning strike and to transmit a lightning induced current. The system further includes a fibre optic current sensor which is configured to detect multiple lightning parameters from the lightning induced current and to modulate a beam of radiation in response thereto by means of Faraday rotation.

U.S. Pat. No. 6,741,069 discloses a lightning detection system for a wind turbine. The system comprises a detector with a power supply, a measuring circuit, and a recording device that is non-galvanically, i.e. optically, coupled to a converter and a measuring coil that is inductively coupled to a lightning conductor. The power supply receives its electrical energy directly from the lightning current via an inductive power coil.

Both of these known systems use electronics to convert a signal quantifying the lightning current to an optical signal so that any remote monitoring apparatus is not connected electrically to the lightning detection system and there is therefore little risk of the lightning current being transmitted to the remote monitoring apparatus.

However, such systems require a dedicated decoder at the remote monitoring apparatus to convert the received optical signals back to electrical signals for further processing of the information they contain. It would be desirable to integrate a galvanically-isolated lightning detection system into the condition monitoring equipment of a wind turbine without the need to provide additional dedicated equipment. The present invention, at least in its preferred embodiments, seeks to provide such a system.

### SUMMARY OF THE INVENTION

Accordingly, this invention provides apparatus for detecting lightning currents. The apparatus comprises a detection conductor for carrying a current representative of a lightning current and a sensitive element electrically connected to the detection conductor. The apparatus further comprises an optical fibre strain sensor mechanically connected to the sensitive element. In use, a lightning current results in expansion of the sensitive element, whereby the optical fibre strain sensor produces an optical signal indicative of the strain on the sensitive element due to the expansion.

In accordance with the invention, an optical signal which is indicative of parameters of the lightning current is produced by the optical fibre strain sensor. In structures such as wind turbines, optical fibre strain sensors are often provided to monitor strains on the structure. With the apparatus according to the invention, data indicative of lightning currents can be determined by an instrument configured to interrogate optical fibre strain sensors, for example as described in WO2004/056017. This significantly simplifies the integration of a lightning detector into a structural monitoring system for structures such as wind turbines.

Typically, the optical fibre strain sensor comprises a fibre Bragg grating. The strain sensor may be mounted to the sensitive element. For example, the strain sensor may be bonded to the sensitive element. Alternatively, the strain sensor may be incorporated into the sensitive element. For example the strain sensor may be embedded in the sensitive element. In general, the optical fibre strain sensor is connected by means of an optical fibre to a remote device for interrogating the optical fibre strain sensor, for example as described in WO2004/056017.

It is possible for the detection conductor to be a lightning conductor. Alternatively, the detection conductor may be a conductor arranged in parallel with the lightning conductor. However, these arrangements are not preferred.

In the presently preferred embodiment, the detection conductor is an inductive loop (or antenna). In use, the inductive loop is arranged proximate a lightning conductor, such that a lightning current in the lightning conductor induces a current in the inductive loop. The inductive loop may comprise one or more turns about a first axis. Desirably, the first axis is arranged substantially perpendicularly to the direction of current flow in the lightning conductor.

In one embodiment, the sensitive element is a resistance, for example a resistor. The expansion of the resistance is a result of Ohmic heating due to the current in the sensitive element. In this way, thermal expansion of the resistance results in a change in the strain measurement indicated by the optical fibre strain sensor. Typically, the resistance is arranged in series with the inductive loop. In this way, the current through the resistance and the consequent temperature rise is a function of the current induced in the inductive loop.

Where the sensitive element is a resistance it is only necessary for the optical fibre strain sensor to be mechanically connected to the sensitive element to the extent that there is thermal contact between the resistance and the strain sensor, as the strain sensor itself may expand on heating. Thus, any expansion of the sensitive element may be relatively small provided that the effect on the optical fibre strain sensor is sufficient to generate a suitable optical signal. In the case of a resistance as the sensitive element, the optical fibre strain sensor may be arranged to act as an optical fibre temperature sensor.

In an alternative embodiment, the sensitive element is a piezoelectric element. A voltage applied to a piezoelectric element results in linear expansion of the element. The piezoelectric element may arranged in parallel with the detection conductor (inductive loop). In this way, a current through the detection conductor applies a voltage across the piezoelectric element.

A capacitance may be arranged in series with the detection conductor and in parallel with the piezoelectric element. In this way, the current through the detection conductor may be integrated, such that the voltage across the piezoelectric element represents the integrated current due to a lightning strike. A resistance may be provided in series with the capacitance to provide the desired time constant for the integrator.

A diode may be provided in series between the detection conductor and the capacitance. The diode may be arranged to prevent the capacitance discharging through the detection conductor. A resistance may be arranged in parallel with the capacitance. The capacitor may be arranged to discharge through this resistance. The piezoelectric element may be arranged in parallel with this resistance. In this way, the piezoelectric element may be arranged to indicate the peak current due to the lightning current.

This arrangement in itself is believed to be novel and thus from further aspect the invention provides apparatus for detecting lightning currents, the apparatus comprising:
a detection conductor for carrying a current representative of a lightning current;
a capacitance arranged in series with the detection conductor;
at least one diode in series between the detection conductor and the capacitance; and
a voltage measuring device arranged in parallel with the detection conductor.

The apparatus may comprise a rectifier in series between the detection conductor and the capacitance. Thus, the diode may form part of a rectifier. The rectifier may be a full-wave rectifier or a half-wave rectifier. Two half-wave rectifiers in parallel may be used to detect positive and negative lightning on respective detector channels.

Embodiments of the invention can comprise two sensitive elements, for example a resistance and a piezoelectric element.

### BRIEF DESCRIPTION OF THE DRAWINGS

An embodiment of the invention will now be described by way of example only and with reference to the accompanying drawings, in which

FIG. 1 is a schematic diagram of a lightning detector according to an embodiment of the invention.

### DETAILED DESCRIPTION OF AN EMBODIMENT

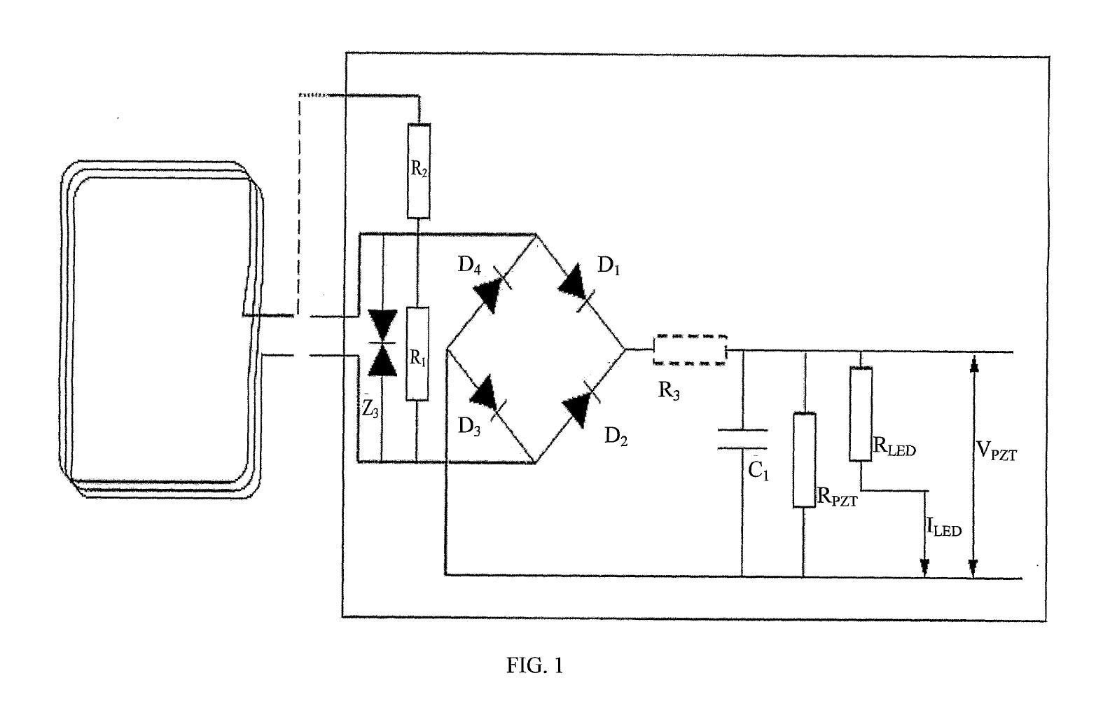

FIG. 1 is a schematic diagram of a lightning detector according to an embodiment of the invention. An inductive loop antenna 1 is arranged in the vicinity of a lightning conductor. The axis of the antenna 1 about which the turns of the loop are wound is arranged substantially perpendicularly to the direction of current flow through the lightning conductor. In this way, the inductive coupling between the lightning conductor and the antenna is maximised.

The antenna 1 is arranged in parallel with one or more Zener diodes Z₃ which protects the rest of the circuit from excessive current surges. A first resistor R₁ is arranged in parallel with the antenna 1 to dissipate the induced current in the antenna. A second resistor R₂ is provided in series with the first resistor R₁ to form a potential divider in order to limit the voltage applied to the components of the device that are in parallel with the first resistor R₁. A full wave rectifier D₁-D₄ is provided across the first resistor R₁ to provide a rectified voltage across a capacitor C₁. An optional resistor R₃ is provided between the rectifier D₁-D₄ and the capacitor C₁. Without the optional resistor R₃ the capacitor C₁ will charge quickly and will represent the peak current induced by the lightning conductor in the antenna 1. With the optional resistor R₃ in the position indicated, the capacitor C₁ will charge more slowly and will act as an integrator.

An output resistor R_{PZT} is provided in parallel with the capacitor C₁. The resistance of the output resistor R_{PZT} is relatively large so that the capacitor C₁ discharges relatively slowly through this resistor. Thus, the voltage across the capacitor C₁ appears as an output voltage V_{PZT} which is applied across a piezoelectric element (not shown). The piezoelectric element expands as a function of the applied voltage and the expansion is determined by a fibre Bragg grating strain sensor bonded to the piezoelectric element.

It is also possible to determine the current through the antenna 1 using a fibre Bragg grating strain sensor bonded to a resistor, such a first resistor R₁ in series with the antenna 1. Thermal expansion of the resistor is measured by the fibre Bragg grating as an indicator of current through the resistor.

In FIG. 1, a resistance R_{LED} in series with a light emitting diode drawing current I_{LED} is indicated as an alternative to the output resistor R_{PZT} and piezoelectric element. The optical output of the LED is representative of the voltage across the capacitor C₁.

The table below shows some example values for the components of the device in four possible configurations (PZT1, PZT2, LED1, LED2) of the circuit and the general range of values for the components.

| | PZT1 | | PZT2 | | LED1 | | LED2 | | Range |
|---|---|---|---|---|---|---|---|---|---|
| R₁ | 0.1 | Ω | 1.5 | kΩ | 725 | kΩ | 0.1 | Ω | 0.01 Ω to 1 MΩ |
| R₂ | 51 | Ω | 0.1 | Ω | 0.1 | Ω | 51 | Ω | 0.01 Ω to 1 kΩ |
| R₃ | 100 | Ω | 2.2 | kΩ | 51 | Ω | 51 | Ω | 1 Ω to 100 kΩ |
| C₁ | 100 | nF | 4.4 | nF | 200 | nF | 200 | nF | 0.1 nF to 1 mF |

| | | | | | | | |
|---|---|---|---|---|---|---|---|
| R_{PZT} | 1 | MΩ | 33 | MΩ | — | — | 0.1 MΩ to 1,000 MΩ |

| | | | | | | | |
|---|---|---|---|---|---|---|---|
| R_{LED} | — | — | 3 | kΩ | 1.5 | kΩ | 100 Ω to 100 kΩ |

The device shown in FIG. 1 can be used to determine peak current in the antenna, as well as peak rate of change of current (DI/DT)

### Calculating Peak DI/DT

If the configuration and position of the antenna 1 is fixed relative to the lightning conductor and assuming that the current increases in a linear fashion:

EMF=−N*[(μ₀*Iₚₑₐₖ*L)/(2π*tₜₒₚₑₐₖ)]*ln((d+r₀)/(r₀)).

### Where:

N number of turns in the coil;
μ₀ Permittivity of a vacuum;
Iₚₑₐₖ the peak current;
L the length of a rectangular loop parallel to the lightning conductor;
tₜₒₚₑₐₖ the time for the current to reach the peak value;
d the length of a rectangular loop perpendicular to the lightning conductor;
r₀ the distance of the closest edge of the loop to the lightning conductor.
Equation 1. Induced EMF in a rectangular coil.

If it is assumed that the current increases linearly with time:

di/dt=Iₚₑₐₖ/tₜₒₚₑₐₖ

The use of a full wave bridge rectifier allows the detection of both positive and negative lightning strikes. However, there will also be detection of the falling edge of the current peak. Assuming that the fall in current will occur at a slower rate than the rise, the peak rate of change measurement will detect di/dt of the front edge of the current pulse due to a lightning strike.

Equation 1 rearranges to give di/dt in terms of the EMF, where all other values are known and remain constant during the strike:

di/dt=(EMF*2π)/[(N*μ₀*L)*ln((d+r₀)/(r₀))]
Equation 2. Peak di/dt in terms of the measured EMF.

Measurements of the EMF induced in the induction coil can be made using either the PZT or LED transducer.

### PZT Measurements

The PZT transducer relies on the induced EMF energising a PZT stack. The relative change in size of the stack is measured using an FBG. The peak EMF detected in the induction coil is given by:

EMF=V_{f}+[C_{PZT}*λₘ]

### Where:

EMF is EMF induced in the induction coil;
V_{f} is the forward voltage of the rectifier diodes, which is typically 1V;
C_{PZT} is the appropriate PZT calibration constant;
λₘ is the change in wavelength in nm measured by the FBG.
Equation 3. Calculating EMF from the PZT transducer.

### Calculating the Peak Current

The peak current can be calculated by measuring the heating in a resistor and using the value of di/dt calculated above.

The power dissipated as heat in a resistor connected directly to an inductive loop can be expressed as: P=V̂2/R

### Where:

P is the dissipated power;
V is the voltage across the resistor;
R is the resistance of the resistor.
Equation 4. The Power Dissipated as Heat in a Resistor.

If it is assumed that the temperature rise in the resistor occurs almost instantaneously, i.e. there is no gradual dissipation of heat during the strike, then total energy that will be dissipated=∫P dt and the corresponding rise in temperature of the resistor will be defined by the heat capacity. If V is the EMF, then using

$$\begin{matrix}E = \int [ {( k m )}^{⋀} 2 / R ] d t \\ = {( k m )}^{⋀} 2 / R \int d t \\ = {( k m )}^{⋀} 2 / R * Δ t\end{matrix} \qquad Equation 1$$

Where:
   E is the energy deposited in the strike;
   k=−N*[(μ₀*L)/(2π)]*Ln((d+r₀)/(r₀));
   m is di/dt, which is assumed to be constant during the strike;
   R is the value of the resistor;
   Δt is the duration of the strike.
   Equation 5. Energy deposited during the strike.

If it is assumed that the rise in current is linear, then the peak current is given by mΔt; hence Equation 5 can be re-arranged to give:

mΔt=ER/m(k̂2)

∴Peak Current=ER/m(k̂2)
Equation 6. Calculation of the Peak Current.

Where E can be measured from the temperature rise of the resistor and m is determined from the previous calculations.

The energy deposited in the strike can be calculated from the temperature rise in the resistor, using the calculated heat capacity. The temperature rise is proportional to the relative shift in wavelength of the thermally coupled FBG:

ΔT=Δλ/(λ₀*(α_{Λ}+αₙ))

### Where:

ΔT is the total rise in temperature
α_{Λ} is the thermal expansion co-efficient of the fibre (0.55E−6 per Deg C)
αₙ is the thermo-optic constant of the fibre (8.5E−6 per Deg C)
λ₀ is a zero wavelength (at the starting temperature)
Δλ is the shift from the zero wavelength (Δλ, λₘ−λ₀ where is λₘ is the measured wavelength).
Equation 7. Temperature rise using FBG.

Hence the energy deposited can be written as:

E=Δλ/S(λ₀*(α_{Λ}+αₙ))

Where: S is the heat capacity of the resistor.
Equation 8. Energy deposited in the resistor in terms of the measured wavelength.

Therefore, combining Equation 5, Equation 7 and Equation 8:

Peak Current=[Δλ/S(λ₀*(α_{Λ}+αₙ))R]/[m((−N*[(μ₀*L)/(2π)]*ln((d+r₀)/(r₀)))̂2)]
Equation 9. Calculating the Peak Current.

This equation assumes that the rise-time of the pulse is much shorter than the fall-time.

In summary, a device for detecting lightning currents in a wind turbine comprises an inductive loop 1 for carrying a current representative of a lightning current and a sensitive element, such as a resistance or a piezoelectric element electrically connected to the inductive loop 1. The apparatus further comprises an optical fibre strain sensor mechanically connected to the sensitive element, such that, in use, a lightning current results in expansion of the sensitive element and the optical fibre strain sensor produces an optical signal indicative of the strain on the sensitive element due to the expansion. The device has the advantage that the optical signal from the optical fibre strain sensor can be processed by the same signal processing equipment that processes signals from other strain sensors provided on the wind turbine.

1. Apparatus for detecting lightning currents, the apparatus comprising:
a detection conductor for carrying a current representative of a lightning current;
a sensitive element electrically connected to the detection conductor; and
an optical fibre strain sensor mechanically connected to the sensitive element,
wherein, in use, a lightning current results in expansion of the sensitive element, whereby the optical fibre strain sensor produces an optical signal indicative of the strain on the sensitive element due to the expansion.

2. Apparatus as claimed in claim 1, wherein the detection conductor is an inductive loop arranged, in use, proximate a lightning conductor, such that a lightning current in the lightning conductor induces a current in the inductive loop.

3. Apparatus as claimed in claim 1 or 2, wherein the sensitive element is a resistance and the expansion of the resistance is a result of Ohmic heating due to the current in the sensitive element.

4. Apparatus as claimed in claims 2 and 3, wherein the resistance is arranged in series with the inductive loop.

5. Apparatus as claimed in claim 1 or 2, wherein the sensitive element is a piezoelectric element.

6. Apparatus as claimed in claim 5, wherein the piezoelectric element is arranged in parallel with the detection conductor.

7. Apparatus as claimed in claim 6 comprising a capacitance arranged in series with the detection conductor and in parallel with the piezoelectric element.

8. Apparatus as claimed in claim 7 comprising at least one diode in series between the detection conductor and the capacitance.

9. Apparatus for detecting lightning currents, the apparatus comprising:
a detection conductor for carrying a current representative of a lightning current;
a capacitance arranged in series with the detection conductor;
at least one diode in series between the detection conductor and the capacitance; and
a voltage measuring device arranged in parallel with the detection conductor.

10. Apparatus as claimed in claim 8 or 9 comprising a rectifier in series between the detection conductor and the capacitance.
